(19) United States
(12) Patent Application Publication
(10) Pub. No.: US 2023/0378499 A1
(43) Pub. Date: Nov. 23, 2023

(54) FUEL CELL SYSTEM

(71) Applicant: TOYOTA JIDOSHA KABUSHIKI KAISHA, Toyota-shi (JP)

(72) Inventors: Masashi TOIDA, Nagoya-shi (JP); Manabu TAKAHASHI, Toyota-shi (JP); Yutaka TANO, Toyota-shi (JP)

(21) Appl. No.: 18/318,797

(22) Filed: May 17, 2023

(30) Foreign Application Priority Data
May 20, 2022 (JP) 2022-082931

(51) Int. Cl. H01M 8/04746; H01M 8/04082; H01M 8/0438; H01M 8/04225; H01M 8/04228

(52) U.S. Cl. CPC H01M 8/04753; H01M 8/04201; H01M 8/04395; H01M 8/04225; H01M 8/04228

(57) ABSTRACT

A fuel cell system includes: a fuel cell stack; an oxygen tank; an oxygen pipe connecting the fuel cell stack and the oxygen tank; an oxygen regulator disposed in the oxygen pipe and configured to regulate a flow rate of oxygen to be supplied from the oxygen tank to a cathode of the fuel cell stack; an oxygen stop valve disposed in the oxygen pipe; and a controller configured to execute, when activating or stopping the fuel cell stack: a first process of opening the oxygen stop valve and the oxygen regulator; a second process of closing the oxygen stop valve and the oxygen regulator when a cathode internal pressure reaches a predetermined first cathode pressure; and a third process of outputting a signal indicating occurrence of oxygen leakage when the cathode internal pressure after a predetermined period is lower than a predetermined second cathode pressure.

### CROSS-REFERENCE TO RELATED APPLICATION

This application claims priority to Japanese Patent Application No. 2022-082931 filed on May 20, 2022, incorporated herein by reference in its entirety.

### BACKGROUND

### 1. Technical Field

The technology disclosed herein relates to a fuel cell system.

### 2. Description of Related Art

General fuel cell systems use an injector to supply fuel in a fuel tank to a fuel cell stack (for example, Japanese Unexamined Patent Application Publication No. 2021-099935 (JP 2021-099935 A)). Many fuel cell systems use oxygen in the atmosphere, but some fuel cell systems use oxygen in an oxygen tank as in a fuel cell system disclosed in, for example, Japanese Unexamined Patent Application Publication No. 2021-034132 (JP 2021-034132 A). When the oxygen tank is used, it is expected that the injector is also used to supply oxygen in the oxygen tank to the fuel cell stack.

### SUMMARY

A typical injector has the following structure. The injector includes a needle that closes a gas ejection port, and a solenoid that moves the needle. The needle is pushed against the gas ejection port by a spring to close the gas ejection port when the solenoid is not energized. When the solenoid is energized, the needle retreats to open the gas ejection port. When the solenoid is de-energized, the needle returns to close the gas ejection port. At this time, hitting noise is generated.

The injector needs to be turned ON and OFF frequently to regulate the internal pressure of the fuel cell stack. When the injector is turned ON and OFF frequently, the needle frequently hits the edge of the gas ejection port to generate the hitting noise.

A fuel cell system that uses the oxygen tank and does not use the injector is disclosed herein. The fuel cell system disclosed herein is excellent in quietness because the injector is not used. The fuel cell system disclosed herein uses a stop valve and a regulator in place of the injector. Further, an oxygen leakage check technology using the stop valve and the regulator is provided herein. In the following description, the “fuel cell” will be referred to as “FC” for the sake of simplicity. The “fuel cell system” will be referred to as “FC system”, and the “fuel cell stack” will be referred to as “FC stack”.

A fuel cell system (FC system) according to a first aspect of the present disclosure includes: a fuel cell stack (FC stack); an oxygen tank; an oxygen pipe connecting the FC stack and the oxygen tank; an oxygen regulator disposed in the oxygen pipe and configured to regulate a flow rate of oxygen to be supplied from the oxygen tank to a cathode of the FC stack; an oxygen stop valve disposed in the oxygen pipe; and a controller. The controller is configured to execute, when activating or stopping the FC stack: a first process of opening the oxygen stop valve and the oxygen regulator; a second process of closing the oxygen stop valve and the oxygen regulator when a cathode internal pressure of the FC stack (pressure in the cathode) reaches a predetermined first cathode pressure; and a third process of outputting a signal indicating occurrence of oxygen leakage when the cathode internal pressure after a predetermined period is lower than a predetermined second cathode pressure.

In the FC system disclosed herein, the oxygen regulator and the oxygen stop valve may regulate the cathode internal pressure of the FC stack in place of the injector. The regulator may be a valve that regulates the flow rate by changing the area of a channel. The regulator is excellent in quietness as compared with the injector because it does not have a needle that advances or retreats with a solenoid like the injector. Further, the oxygen leakage check can be performed by using the oxygen stop valve and the oxygen regulator.

The FC system according to the first aspect of the present disclosure may further include: an oxygen tank valve attached to the oxygen pipe between the oxygen stop valve and the oxygen tank; and an exhaust oxygen valve configured to stop discharge of gas from a cathode gas outlet of the FC stack. The controller may be configured to, when stopping the FC stack, before execution of the first process, the second process, and the third process, open the oxygen tank valve, the oxygen stop valve, the oxygen regulator, and the exhaust oxygen valve so as to discharge water remaining in the cathode from the FC stack; and close the oxygen stop valve and the exhaust oxygen valve and, when an internal pressure of the oxygen pipe on an upstream side of the oxygen stop valve reaches an upper limit cathode pressure higher than the predetermined first cathode pressure, close the oxygen tank valve.

According to the above FC system, the oxygen leakage check process can immediately be executed because the internal pressure of the oxygen pipe on the upstream side of the oxygen stop valve is high after the cathode scavenging process for discharging water from the cathode.

Details of the technology disclosed herein and further improvements will be described below in “DETAILED DESCRIPTION OF EMBODIMENTS”.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram of an FC system of an embodiment;

FIG. 2 is a main flowchart of a gas leakage check process when activating an FC stack;

FIG. 3 is a flowchart of a fuel leakage check process;

FIG. 4 is a flowchart of an oxygen leakage check process;

FIG. 5 is a main flowchart of a gas leakage check process when stopping the FC stack;

FIG. 6 is a flowchart of a cathode scavenging process; and

FIG. 7 is a flowchart of an anode scavenging process.

### DETAILED DESCRIPTION OF EMBODIMENTS

The FC system according to the first aspect of the present disclosure may further include an exhaust oxygen pipe connected to the cathode gas outlet. The exhaust oxygen valve may be provided in the exhaust oxygen pipe.

In the FC system according to the first aspect of the present disclosure, the controller may be configured to, when activating or stopping the fuel cell stack, output the signal indicating the occurrence of the oxygen leakage in a case where the cathode internal pressure after the predetermined period is not lower than the predetermined second cathode pressure and an amount of decrease in an internal pressure of the oxygen pipe on an upstream side of the oxygen stop valve during the predetermined period is larger than a permissible decrease amount.

The FC system according to the first aspect of the present disclosure may further include a first pressure sensor provided in the oxygen pipe on a downstream side of the oxygen stop valve and configured to measure the cathode internal pressure. The controller may be configured to acquire the measured cathode internal pressure from the first pressure sensor.

The FC system according to the first aspect of the present disclosure may further include a second pressure sensor provided in the oxygen pipe on the upstream side of the oxygen stop valve and configured to measure the internal pressure of the oxygen pipe on the upstream side of the oxygen stop valve. The controller may be configured to acquire the measured internal pressure from the second pressure sensor.

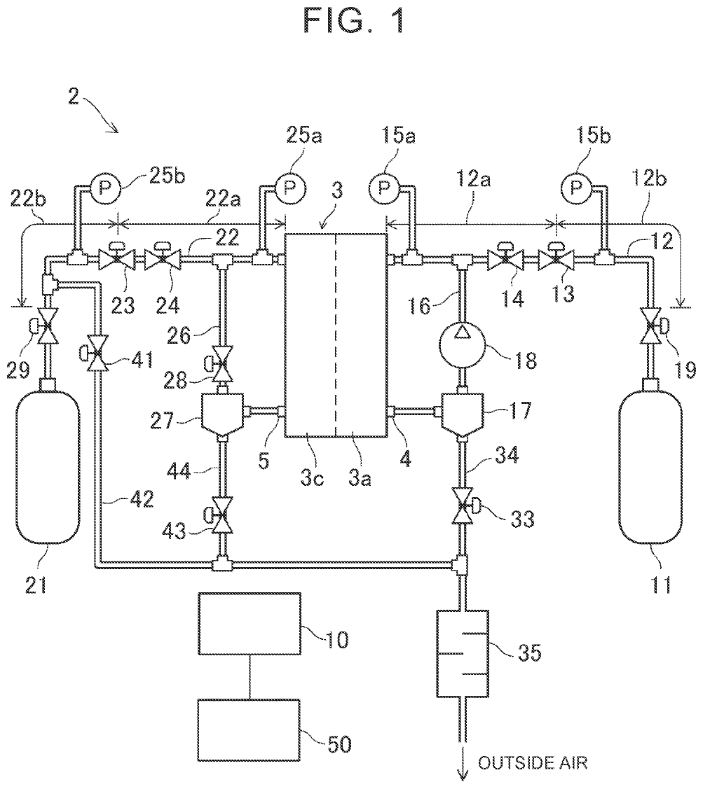

A fuel cell system 2 (FC system 2) of an embodiment will be described with reference to the drawings. FIG. 1 is a block diagram of the FC system 2. The FC system 2 includes an FC stack 3 and a fuel tank 11. The fuel tank 11 stores fuel gas (hydrogen gas). As is well known, the FC stack 3 causes hydrogen and oxygen to react with each other to obtain electric power. Many FC systems use oxygen in the air, but the FC system 2 of the embodiment includes an oxygen tank 21, and causes oxygen in the oxygen tank 21 to react with the fuel gas in the fuel tank 11 to obtain electric power. The gas stored in the oxygen tank 21 may be a gas mixture of oxygen and other molecules. For example, the oxygen tank 21 may store a gas mixture (that is, air) containing 78% of nitrogen, 21% of oxygen, and 1% of other components.

The FC system 2 includes, for example, a plurality of valves (fuel tank valve 19 and the like), a plurality of pressure sensors 15a, 15b, 25a, and 25b, and a plurality of temperature sensors (not shown). All the valves are controlled by a controller 10. Values measured by all the sensors are sent to the controller 10.

A fuel system of the FC system 2 will be described. The fuel tank 11 and the FC stack 3 are connected by a fuel pipe 12. As is well known, the inside of the FC stack 3 is divided into an anode 3a (fuel electrode) and a cathode 3c (oxygen electrode). The fuel pipe 12 connects the fuel tank 11 and the anode 3a of the FC stack 3, and sends the fuel gas from the fuel tank 11 to the anode 3a.

The fuel pipe 12 is provided with the fuel tank valve 19, a fuel stop valve 13, and a fuel regulator 14. The fuel tank valve 19 is disposed at the end of an upstream side in the fuel pipe 12 (position closest to the fuel tank 11) and stops outflow of the fuel gas from the fuel tank 11. When the FC stack 3 is stopped, the fuel tank valve 19 is closed and the safety of the FC system 2 is ensured.

The fuel regulator 14 is disposed on a downstream side in the fuel pipe 12 (position closest to the FC stack 3) and regulates the flow rate of the fuel gas to be supplied to the anode 3a. The fuel stop valve 13 is attached to the fuel pipe 12 between the fuel regulator 14 and the fuel tank valve 19.

The fuel tank valve 19 and the fuel stop valve 13 can be switched only between a fully open state and a fully closed state. The fuel regulator 14 is a valve that can continuously change the area of a channel, and can regulate the flow rate of the fuel gas. The fuel regulator 14 and the fuel stop valve 13 function as an injector. That is, when the controller 10 operates the FC stack 3, the controller 10 opens the fuel stop valve 13 and controls the fuel regulator 14 so that an anode internal pressure of the FC stack 3 (pressure in the anode 3a) is maintained within a predetermined appropriate anode pressure range.

The fuel stop valve 13 is used to quickly stop the supply of fuel to the FC stack 3 when any abnormality occurs during the operation of the FC stack 3.

The fuel pipe 12 connects the fuel tank 11 and the FC stack 3. For convenience of description, a part of the fuel pipe 12 between the FC stack 3 and the fuel stop valve 13 is referred to as “low-pressure fuel pipe 12a”, and a part of the fuel pipe 12 between the fuel stop valve 13 and the fuel tank valve 19 is referred to as “high-pressure fuel pipe 12b”.

The pressure sensors 15a and 15b are attached to the low-pressure fuel pipe 12a and the high-pressure fuel pipe 12b, respectively. The pressure sensor 15a measures an internal pressure of the low-pressure fuel pipe 12a. The internal pressure of the low-pressure fuel pipe 12a is equal to the anode internal pressure. The pressure sensor 15b measures an internal pressure of the high-pressure fuel pipe 12b. The controller 10 uses the measured value of the pressure sensor 15a to control the fuel regulator 14 so that the anode internal pressure is maintained within the predetermined appropriate anode pressure range.

A gas-liquid separator 17 is connected to an anode gas outlet 4 of the FC stack 3. The gas-liquid separator 17 separates unreacted fuel gas from the gas discharged from the anode gas outlet 4. The separated fuel gas is reused by being returned to the low-pressure fuel pipe 12a through a return channel 16. A pump 18 is provided in the return channel 16 and forcibly returns the unreacted fuel gas to the low-pressure fuel pipe 12a.

An exhaust gas pipe 34 is connected to a gas outlet of the gas-liquid separator 17, and a muffler 35 is attached midway along the exhaust gas pipe 34. Impurities separated by the gas-liquid separator 17 are released to the outside through the exhaust gas pipe 34 and the muffler 35. Oxygen is also sent to the muffler 35 from the oxygen tank 21 through a bypass pipe 42. A regulator 41 is attached to the bypass pipe 42. A small amount of fuel remains in the impurities discharged from the gas-liquid separator 17. The fuel in the impurities discharged from the gas-liquid separator 17 is hereinafter referred to as “residual fuel”. The controller 10 estimates (or measures) the concentration of the residual fuel in the exhaust gas to be released from the muffler 35 to the outside (that is, the exhaust gas to be released from the FC system 2 to the outside). A fuel concentration measuring device may be provided in the muffler 35 or on a downstream side of the muffler 35. The installation position of the measuring device is not limited to the above position. The controller 10 regulates the amount of oxygen to be sent from the oxygen tank 21 to the muffler 35 through the bypass pipe 42 so that the concentration of the residual fuel contained in the exhaust gas falls below a predetermined upper limit release concentration. The regulator 41 regulates the amount of oxygen to be sent from the oxygen tank 21 to the muffler 35.

An exhaust fuel valve 33 is attached midway along the exhaust gas pipe 34. The exhaust fuel valve 33 closes the exhaust gas pipe 34 to stop outflow of the exhaust gas containing the residual fuel.

An oxygen system of the FC system 2 will be described. The oxygen tank 21 and the cathode 3c (oxygen electrode) of the FC stack 3 are connected by an oxygen pipe 22, and oxygen is sent from the oxygen tank 21 to the cathode 3c.

The oxygen pipe 22 is provided with an oxygen tank valve 29, an oxygen stop valve 23, and an oxygen regulator 24. The oxygen tank valve 29 is disposed at the end of an upstream side in the oxygen pipe 22 (position closest to the oxygen tank 21) and stops outflow of oxygen from the oxygen tank 21. When the FC stack 3 is stopped, the oxygen tank valve 29 is closed and unnecessary outflow of oxygen is suppressed.

The oxygen regulator 24 is disposed on a downstream side in the oxygen pipe 22 (position closest to the FC stack 3) and regulates the flow rate of oxygen to be supplied to the cathode 3c. The oxygen stop valve 23 is attached to the oxygen pipe 22 between the oxygen regulator 24 and the oxygen tank valve 29.

The oxygen tank valve 29 and the oxygen stop valve 23 can be switched only between a fully open state and a fully closed state. The oxygen regulator 24 is a valve that can continuously change the area of a channel, and can regulate the flow rate of oxygen. The oxygen regulator 24 and the oxygen stop valve 23 function as an injector. When the controller 10 operates the FC stack 3, the controller 10 opens the oxygen stop valve 23 and controls the oxygen regulator 24 so that a cathode internal pressure of the FC stack 3 (pressure in the cathode 3c) is maintained within a predetermined appropriate cathode pressure range.

The oxygen stop valve 23 is used to quickly stop the supply of oxygen to the FC stack 3 when any abnormality occurs during the operation of the FC stack 3.

The oxygen pipe 22 connects the oxygen tank 21 and the FC stack 3. For convenience of description, a part of the oxygen pipe 22 between the FC stack 3 and the oxygen stop valve 23 is referred to as “low-pressure oxygen pipe 22a”, and a part of the oxygen pipe 22 between the oxygen stop valve 23 and the oxygen tank valve 29 is referred to as “high-pressure oxygen pipe 22b”.

The pressure sensors 25a and 25b are attached to the low-pressure oxygen pipe 22a and the high-pressure oxygen pipe 22b, respectively. The pressure sensor 25a measures an internal pressure of the low-pressure oxygen pipe 22a. The internal pressure of the low-pressure oxygen pipe 22a is equal to the cathode internal pressure. The pressure sensor 25b measures an internal pressure of the high-pressure oxygen pipe 22b. The controller 10 uses the measured value of the pressure sensor 25a to control the oxygen regulator 24 so that the cathode internal pressure is maintained within the predetermined appropriate cathode pressure range.

A gas-liquid separator 27 is connected to a cathode gas outlet 5 of the FC stack 3. The gas-liquid separator 27 separates unreacted oxygen from the gas discharged from the cathode gas outlet 5. The separated oxygen is reused by being returned to the low-pressure oxygen pipe 22a through a return channel 26. A stop valve 28 is provided in the return channel 26. When the oxygen separated by the gas-liquid separator 27 need not be returned to the low-pressure oxygen pipe 22a, the stop valve 28 is closed.

An exhaust oxygen pipe 44 is connected to a gas outlet of the gas-liquid separator 27, and an exhaust oxygen valve 43 is attached midway along the exhaust oxygen pipe 44. When impurities separated by the gas-liquid separator 27 need to be discharged, the exhaust oxygen valve 43 is opened. When the amount of the impurities is extremely small, there is no need to discharge the impurities. Therefore, the exhaust oxygen valve 43 is closed. The impurities separated by the gas-liquid separator 27 are sent to the muffler 35, mixed with the impurities discharged from the gas-liquid separator 17 on the fuel side, and discharged to the outside.

Although the FC system 2 includes several pressure sensors and temperature sensors in addition to the pressure sensors 15a, 15b, 25a, and 25b, illustration and description thereof are omitted.

As described above, the controller 10 controls the valves in the FC system 2. Based on an output command from a host controller 50, the controller 10 regulates the flow rates of the fuel gas and oxygen to be supplied to the FC stack 3 so that the FC stack 3 outputs predetermined target electric power. The controller 10 controls the fuel stop valve 13 and the fuel regulator 14 to regulate the anode internal pressure and the flow rate of the fuel gas to be supplied to the anode 3a of the FC stack 3, and controls the oxygen stop valve 23 and the oxygen regulator 24 to regulate the cathode internal pressure and the flow rate of oxygen to be supplied to the cathode 3c.

In the FC system 2, the FC stack 3, the fuel pipe 12, and the oxygen pipe 22 are checked for gas leakage before activation of the FC stack 3 and immediately after stop of the FC stack 3. A process for checking fuel gas leakage at the anode 3a of the FC stack 3 and the fuel pipe 12 is hereinafter referred to as “fuel leakage check process”, and a process for checking oxygen leakage at the cathode 3c of the FC stack 3 and the oxygen pipe 22 is hereinafter referred to as “oxygen leakage check process”. The fuel leakage check process and the oxygen leakage check process are collectively referred to as “gas leakage check process”. The controller 10 performs the gas leakage check process before the activation of the FC stack 3 and after the stop of the FC stack 3. The activation and stop of the FC stack 3 are executed by the controller 10 based on commands from the host controller 50.

When the controller 10 stops the FC stack 3, the controller 10 also performs scavenging processes for the anode 3a and the cathode 3c. The scavenging process is a process for discharging water remaining inside the FC stack 3 (water produced by hydrogen/oxygen reaction). The scavenging process on the anode 3a side is referred to as “anode scavenging process”, and the scavenging process on the cathode 3c side is referred to as “cathode scavenging process”.

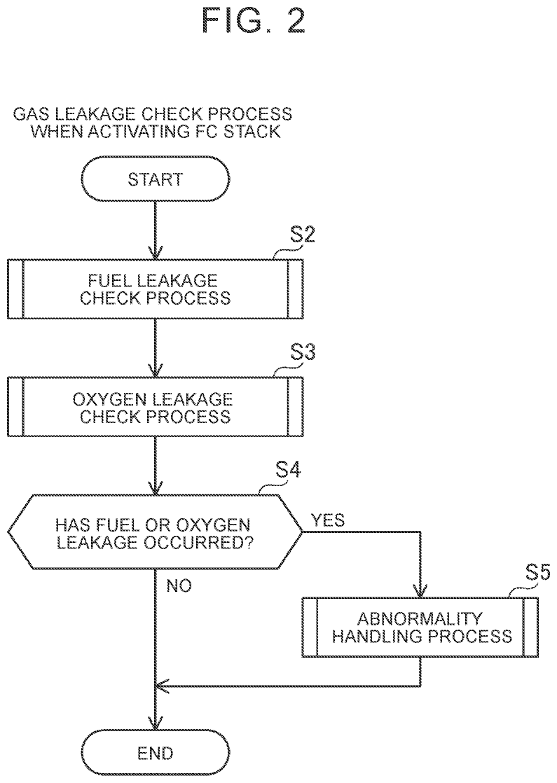

FIG. 2 is a main flowchart of the gas leakage check process to be executed by the controller 10 when the controller 10 activates the FC stack 3. The process of FIG. 2 is executed when the controller 10 receives an activation command for the FC stack 3 from the host controller 50. When the activation command is received, the controller 10 executes the fuel leakage check process (Step S2) and the oxygen leakage check process (Step S3).

The controller 10 outputs a signal indicating the occurrence of leakage to the host controller 50 when the occurrence of fuel leakage is detected in the fuel leakage check process (Step S2) or when the occurrence of oxygen leakage is detected in the oxygen leakage check process (Step S3). The host controller 50 that has received the signal indicating the occurrence of leakage executes a process responding to the occurrence of leakage (abnormality handling process) (Step S4: YES, Step S5). Description of the abnormality handling process is omitted.

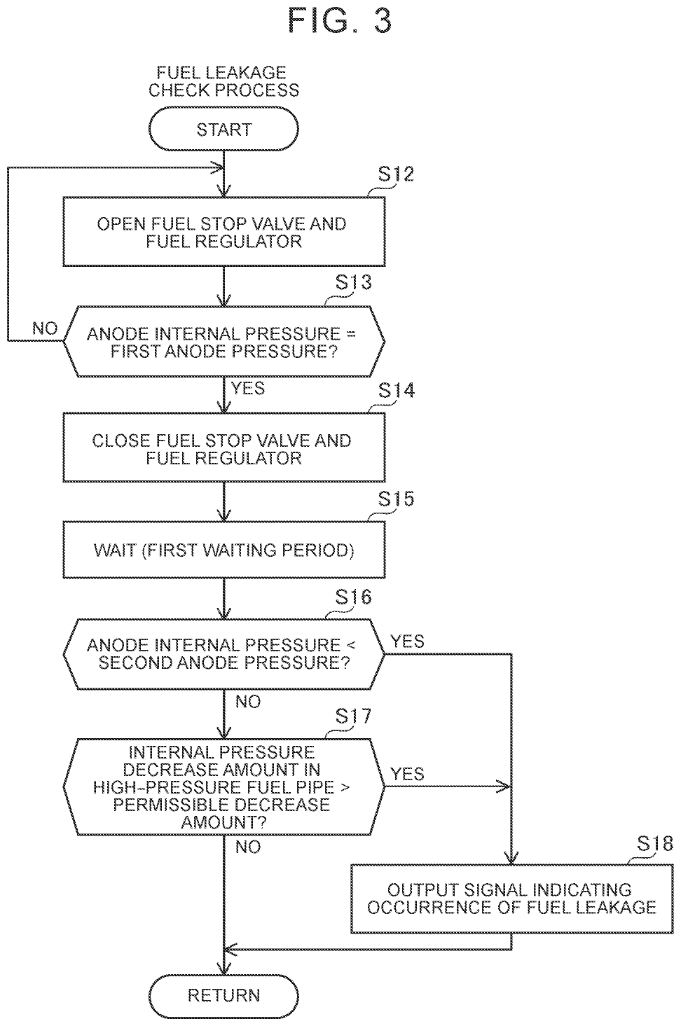

FIG. 3 is a flowchart of the fuel leakage check process. The controller 10 opens the fuel stop valve 13 and the fuel regulator 14 (Step S12). The controller 10 closes the fuel stop valve 13 and the fuel regulator 14 when the internal pressure of the low-pressure fuel pipe 12a (that is, the anode internal pressure) reaches a first anode pressure (Step S13: YES, Step S14). The internal pressure of the low-pressure fuel pipe 12a (that is, the anode internal pressure) is measured by the pressure sensor 15a.

After the fuel stop valve 13 and the fuel regulator 14 are closed, the controller 10 waits for a first waiting period (Step S15). After the wait for the first waiting period, the controller 10 acquires the internal pressure of the low-pressure fuel pipe 12a (that is, the anode internal pressure) from the pressure sensor 15a and compares the acquired anode internal pressure with a second anode pressure (Step S16). The second anode pressure is set to a value lower than the first anode pressure.

When the anode internal pressure after the first waiting period is lower than the second anode pressure, it is found that the fuel is leaking from the anode 3a or the low-pressure fuel pipe 12a. In this case, the controller 10 outputs a signal indicating the occurrence of fuel leakage to the host controller 50 (Step S16: YES, Step S18).

The controller 10 acquires the internal pressure of the high-pressure fuel pipe 12b from the pressure sensor 15b after waiting for the first waiting period. When the amount of pressure decrease in the high-pressure fuel pipe 12b during the first waiting period is larger than a predetermined permissible decrease amount, it is found that the fuel is leaking from the high-pressure fuel pipe 12b. Also in this case, the controller 10 outputs a signal indicating the occurrence of fuel leakage to the host controller 50 (Step S17: YES, Step S18).

The fuel leakage from the anode 3a or the fuel pipe 12 can be checked through the process of FIG. 3. Prior to the fuel leakage check process, the controller 10 opens the fuel tank valve 19 to increase the internal pressure of the high-pressure fuel pipe 12b to an upper limit anode pressure. When the internal pressure of the high-pressure fuel pipe 12b reaches the upper limit anode pressure, the controller 10 closes the fuel tank valve 19 and starts the process of FIG. 3.

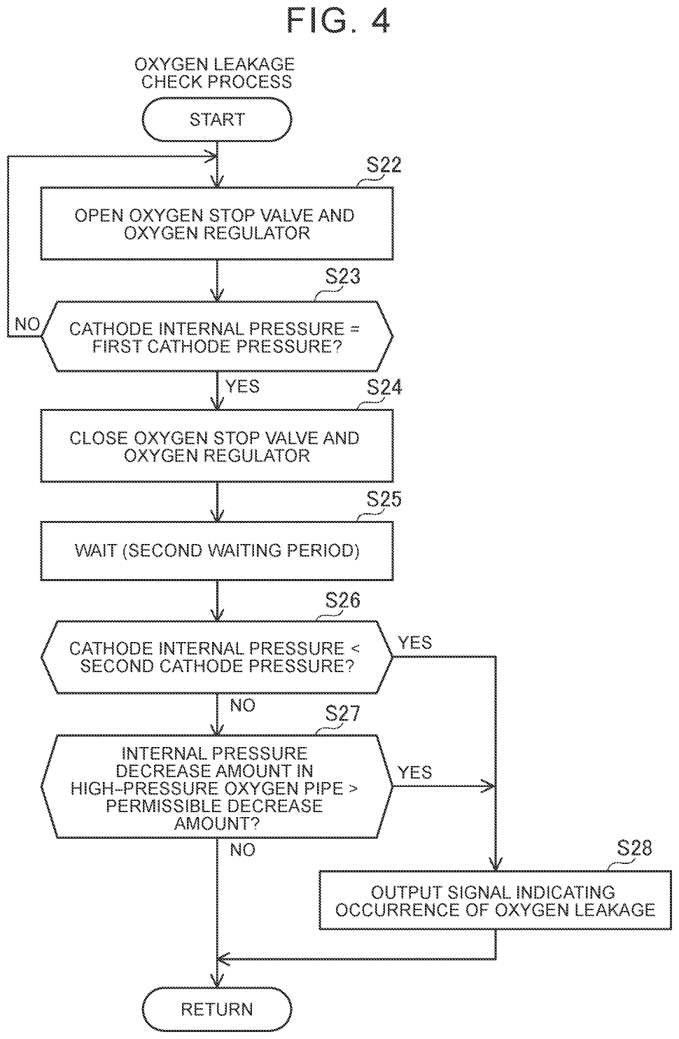

Next, the oxygen leakage check process will be described with reference to FIG. 4. The controller 10 opens the oxygen stop valve 23 and the oxygen regulator 24 (Step S22). The controller 10 closes the oxygen stop valve 23 and the oxygen regulator 24 when the internal pressure of the low-pressure oxygen pipe 22a (that is, the cathode internal pressure) reaches a first cathode pressure (Step S23: YES, Step S24). The internal pressure of the low-pressure oxygen pipe 22a (that is, the cathode internal pressure) is measured by the pressure sensor 25a.

After the oxygen stop valve 23 and the oxygen regulator 24 are closed, the controller 10 waits for a second waiting period (Step S25). After the wait for the second waiting period, the controller 10 acquires the internal pressure of the low-pressure oxygen pipe 22a (that is, the cathode internal pressure) from the pressure sensor 25a and compares the acquired cathode internal pressure with a second cathode pressure (Step S26). The second cathode pressure is set to a value lower than the first cathode pressure.

When the cathode internal pressure after the second waiting period is lower than the second cathode pressure, it is found that oxygen is leaking from the cathode 3c or the low-pressure oxygen pipe 22a. In this case, the controller 10 outputs a signal indicating the occurrence of oxygen leakage to the host controller 50 (Step S26: YES, Step S28).

The controller 10 acquires the internal pressure of the high-pressure oxygen pipe 22b from the pressure sensor 25b after waiting for the second waiting period. When the amount of pressure decrease in the high-pressure oxygen pipe 22b during the second waiting period is larger than a predetermined permissible decrease amount, it is found that oxygen is leaking from the high-pressure oxygen pipe 22b. Also in this case, the controller 10 outputs a signal indicating the occurrence of oxygen leakage to the host controller 50 (Step S27: YES, Step S28).

The controller 10 outputs a signal indicating the occurrence of leakage to the host controller 50 when the occurrence of oxygen leakage is detected in the oxygen leakage check process (Step S3) or when the occurrence of fuel leakage is detected in the fuel leakage check process (Step S2). The host controller 50 that has received the signal indicating the occurrence of leakage executes a process responding to the occurrence of leakage (abnormality handling process) (Step S4: YES, Step S5). Description of the abnormality handling process is omitted.

The oxygen leakage from the cathode 3c or the oxygen pipe 22 can be checked through the process of FIG. 4. Prior to the oxygen leakage check process, the controller 10 opens the oxygen tank valve 29 to increase the internal pressure of the high-pressure oxygen pipe 22b to an upper limit cathode pressure. When the internal pressure of the high-pressure oxygen pipe 22b reaches the upper limit cathode pressure, the controller closes the oxygen tank valve 29 and starts the process of FIG. 4.

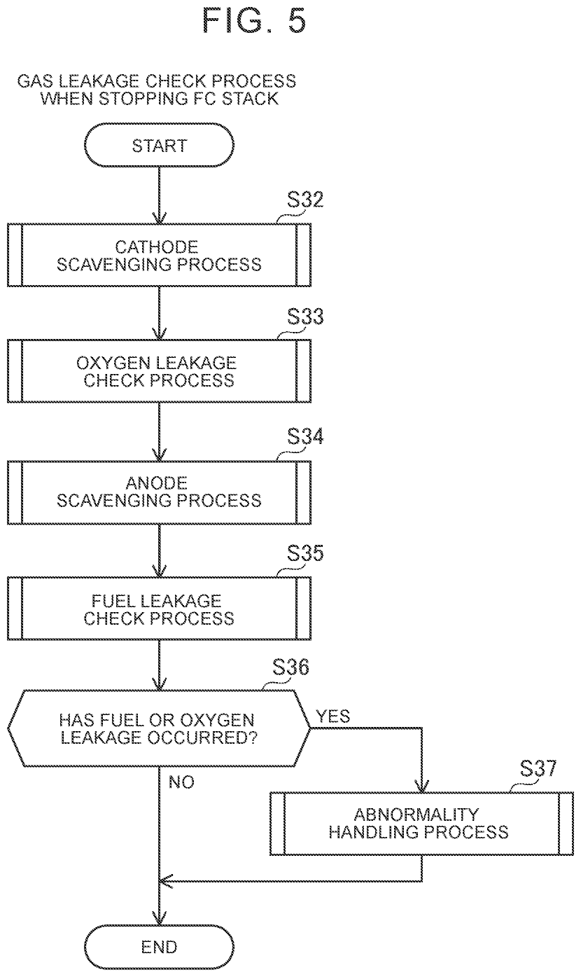

FIG. 5 is a main flowchart of the gas leakage check process when stopping the FC stack 3. When stopping the FC stack 3, the controller 10 executes the oxygen leakage check process (Step S33) before the fuel leakage check process (Step S35). The fuel leakage check process is as shown in FIG. 3, and the oxygen leakage check process is as shown in FIG. 4.

When stopping the FC stack 3, the controller 10 also executes the cathode scavenging process (Step S32) before the oxygen leakage check process (Step S33) and the anode scavenging process (Step S34) before the fuel leakage check process (Step S35).

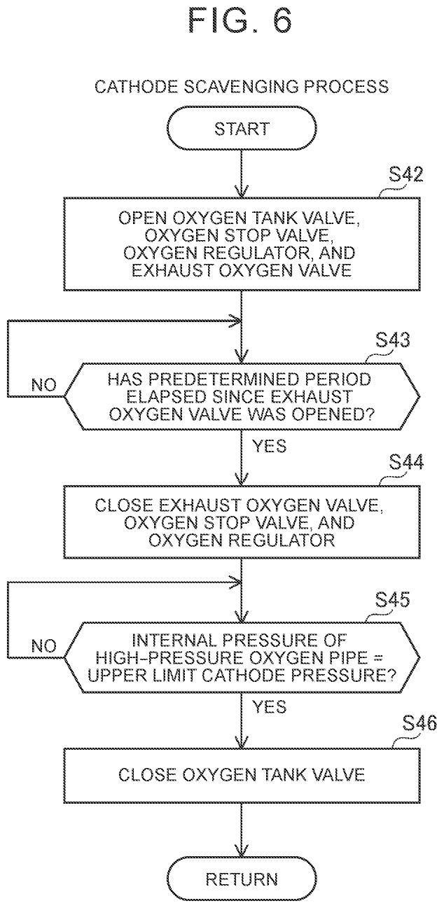

The cathode scavenging process will be described with reference to FIG. 6. The controller 10 opens the oxygen tank valve 29, the oxygen stop valve 23, the oxygen regulator 24, and the exhaust oxygen valve 43 (Step S42). When these valves are opened, oxygen flows intensely through the cathode 3c of the FC stack 3 and water remaining in the cathode 3c is discharged. The oxygen that has passed through the cathode 3c is discharged to the outside through the muffler 35.

The controller 10 closes the exhaust oxygen valve 43, the oxygen stop valve 23, and the oxygen regulator 24 after a predetermined period has elapsed since the exhaust oxygen valve 43 was opened (Step S43: YES, Step S44). At this time, the controller 10 may or may not close the oxygen regulator 24. The predetermined period is a period required for water to be sufficiently discharged from the cathode 3c, and is preset based on, for example, the structure of the FC stack 3.

Although the oxygen stop valve 23 is closed in Step S44, the internal pressure of the high-pressure oxygen pipe 22b increases because the oxygen tank valve 29 remains open. The controller 10 closes the oxygen tank valve 29 when the internal pressure of the high-pressure oxygen pipe 22b reaches the predetermined upper limit cathode pressure (Step S45: YES, Step S46). The upper limit cathode pressure is set to a value higher than the first cathode pressure described above. The internal pressure of the high-pressure oxygen pipe 22b is measured by the pressure sensor 25b.

Subsequently, the oxygen leakage check process (Step S33 in FIG. 5) is executed. Details of the oxygen leakage check process are shown in FIG. 4. In the cathode scavenging process (S32) prior to the oxygen leakage check process (Step S33), the internal pressure of the high-pressure oxygen pipe 22b is increased to the upper limit cathode pressure (>first cathode pressure). Therefore, when the oxygen stop valve 23 and the oxygen regulator 24 are opened in the first process of the oxygen leakage check process (Step S22 in FIG. 4), the internal pressure of the low-pressure oxygen pipe 22a increases. Since the low-pressure oxygen pipe 22a communicates with the cathode 3c of the FC stack 3, the internal pressure of the low-pressure oxygen pipe 22a is equal to the pressure in the cathode 3c (cathode internal pressure). By increasing the internal pressure of the high-pressure oxygen pipe 22b to the upper limit cathode pressure in the cathode scavenging process, the subsequent oxygen leakage check process can be performed smoothly.

After the oxygen leakage check process (Step S33), the anode scavenging process (Step S34) is executed.

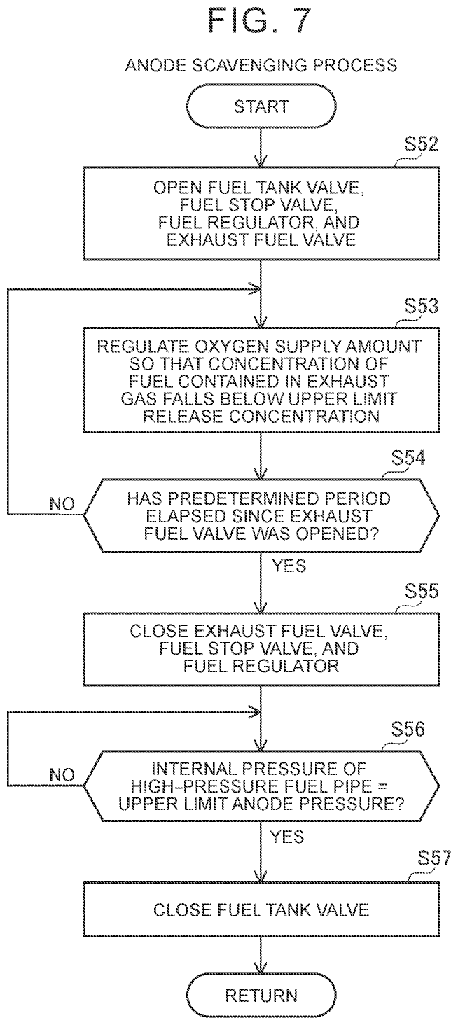

FIG. 7 is a flowchart of the anode scavenging process. The controller 10 opens the fuel tank valve 19, the fuel stop valve 13, the fuel regulator 14, and the exhaust fuel valve 33 (Step S52). When these valves are opened, the fuel gas flows intensely through the anode 3a of the FC stack 3 and water remaining in the anode 3a is discharged.

The fuel gas that has passed through the anode 3a is discharged to the outside through the muffler 35. The controller 10 mixes oxygen in the oxygen tank 21 with the exhaust gas so that the concentration of the fuel contained in the exhaust gas to be discharged to the outside falls below the predetermined upper limit release concentration (Step S53). Specifically, the controller 10 opens the oxygen tank valve 29 and the regulator 41 to supply oxygen to the muffler 35 through the bypass pipe 42. The concentration of the fuel contained in the exhaust gas to be discharged to the outside can be estimated based on the flow rate of the fuel gas output from the fuel tank 11 and the flow rate of oxygen output from the oxygen tank 21. The controller 10 regulates the opening degree of the regulator 41 so that the concentration of the fuel contained in the exhaust gas to be discharged to the outside falls below the predetermined upper limit release concentration.

The controller 10 closes the exhaust fuel valve 33, the fuel stop valve 13, and the fuel regulator 14 after a predetermined period has elapsed since the exhaust fuel valve 33 was opened (Step S54: YES, Step S55). The predetermined period is a period required for water to be sufficiently discharged from the anode 3a, and is preset based on, for example, the structure of the FC stack 3.

Although the fuel stop valve 13 is closed in Step S55, the internal pressure of the high-pressure fuel pipe 12b increases because the fuel tank valve 19 remains open. The controller 10 closes the fuel tank valve 19 when the internal pressure of the high-pressure fuel pipe 12b reaches the predetermined upper limit anode pressure (Step S56: YES, Step S57). The upper limit anode pressure is set to a value higher than the first anode pressure described above. The internal pressure of the high-pressure fuel pipe 12b is measured by the pressure sensor 15b.

Subsequently, the fuel leakage check process (Step S35 in FIG. 5) is executed. Details of the fuel leakage check process are shown in FIG. 3. In the anode scavenging process (Step S34) prior to the fuel leakage check process, the internal pressure of the high-pressure fuel pipe 12b is increased to the upper limit anode pressure (>first anode pressure). Therefore, when the fuel stop valve 13 and the fuel regulator 14 are opened, the internal pressure of the low-pressure fuel pipe 12a increases. Since the low-pressure fuel pipe 12a communicates with the anode 3a of the FC stack 3, the internal pressure of the low-pressure fuel pipe 12a is equal to the pressure in the anode 3a (anode internal pressure). By increasing the internal pressure of the high-pressure fuel pipe 12b to the upper limit anode pressure in the anode scavenging process, the subsequent fuel leakage check process can be performed smoothly.

After the gas leakage check process (FIG. 5) when stopping the FC stack 3, the controller 10 executes an oxygen consumption process (not shown).

The oxygen consumption process will be described. Neither fuel nor oxygen is supplied to the FC stack 3 when the gas leakage check process is finished, but oxygen remains inside the FC stack 3. When stopping the FC stack 3, the fuel leakage check process (Step S35) is executed after the oxygen leakage check process (Step S33). Therefore, sufficient fuel remains in the FC stack 3. In the oxygen consumption process, the controller takes out electric power from the FC stack 3 and causes oxygen and hydrogen remaining in the FC stack 3 to react with each other. The controller 10 takes out electric power from the FC stack 3 until most of oxygen is consumed. Oxygen can be removed from the FC stack 3 by this oxygen consumption process. The electric power taken out from the FC stack 3 is stored in, for example, a battery.

Next, the features and advantages of the FC system 2 will be described. The FC system 2 uses the fuel stop valve 13 (oxygen stop valve 23) and the fuel regulator 14 (oxygen regulator 24) in place of the injector. The FC system 2 is excellent in quietness because the regulator and the stop valve that do not generate hitting noise are used in place of the injector that generates the hitting noise.

When stopping the FC stack 3, the controller 10 of the FC system 2 executes the anode scavenging process prior to the fuel leakage check process. Further, the controller executes the cathode scavenging process prior to the oxygen leakage check process. When the anode scavenging process is finished, the internal pressure of the high-pressure fuel pipe 12b is maintained at the upper limit anode pressure (>first anode pressure). Since the internal pressure of the high-pressure fuel pipe 12b is kept high, the fuel leakage check process can be started immediately after the anode scavenging process. Similarly, when the cathode scavenging process is finished, the internal pressure of the high-pressure oxygen pipe 22b is maintained at the upper limit cathode pressure (>first cathode pressure). Since the internal pressure of the high-pressure oxygen pipe 22b is kept high, the oxygen leakage check process can be started immediately after the cathode scavenging process.

During the anode scavenging process, the controller 10 mixes the oxygen gas into the exhaust gas so that the concentration of the fuel contained in the exhaust gas to be discharged from the FC system 2 falls below the upper limit release concentration. Through this process, gas containing fuel at a high concentration is not released to the atmosphere.

When activating the FC stack 3 in the FC system 2, the oxygen leakage check process is performed after the fuel leakage check process (see FIG. 2). When stopping the FC stack 3, the oxygen leakage check process is performed before the fuel leakage check process (see FIG. 5). These sequences ensure that the FC stack 3 always contains more fuel than oxygen. Oxygen reacts with fuel to change into water. By setting the sequences of the oxygen leakage check process and the fuel leakage check process as in the embodiment, it is possible to suppress a large amount of oxygen from remaining inside the FC stack 3. Deterioration of the catalyst of the FC stack 3 advances when it comes into contact with oxygen, but can be suppressed because a large amount of oxygen does not remain in the FC stack 3 through the process of the embodiment.

The technology disclosed herein is also effective for FC systems that take in oxygen from the atmosphere. In this case, an advantage can be attained from the replacement of the fuel-side injector with the stop valve and the regulator.

Although the specific examples of the present disclosure are described in detail above, these are merely illustrative, and are not intended to limit the scope of the claims. The technology disclosed in the claims encompasses various modifications and changes to the specific examples described above. The technical elements described herein or illustrated in the drawings exhibit technical utility solely or in various combinations, and are not limited to the combination described in the claims as filed. The technologies described herein or illustrated in the drawings may simultaneously achieve a plurality of objects, and exhibit technical utility by achieving one of the objects.

What is claimed is:

1. A fuel cell system comprising:
a fuel cell stack;
an oxygen tank;
an oxygen pipe connecting the fuel cell stack and the oxygen tank;
an oxygen regulator disposed in the oxygen pipe and configured to regulate a flow rate of oxygen to be supplied from the oxygen tank to a cathode of the fuel cell stack;
an oxygen stop valve disposed in the oxygen pipe; and
a controller, wherein
the controller is configured to execute, when activating or stopping the fuel cell stack:
a first process of opening the oxygen stop valve and the oxygen regulator;
a second process of closing the oxygen stop valve and the oxygen regulator when a cathode internal pressure of the fuel cell stack reaches a predetermined first cathode pressure; and
a third process of outputting a signal indicating occurrence of oxygen leakage when the cathode internal pressure after a predetermined period is lower than a predetermined second cathode pressure.

2. The fuel cell system according to claim 1, further comprising:
an oxygen tank valve attached to the oxygen pipe between the oxygen stop valve and the oxygen tank; and
an exhaust oxygen valve configured to stop discharge of gas from a cathode gas outlet of the fuel cell stack, wherein
the controller is configured to, when stopping the fuel cell stack,
before execution of the first process, the second process, and the third process, open the oxygen tank valve, the oxygen stop valve, the oxygen regulator, and the exhaust oxygen valve so as to discharge water remaining in the cathode from the fuel cell stack, and
close the oxygen stop valve and the exhaust oxygen valve and, when an internal pressure of the oxygen pipe on an upstream side of the oxygen stop valve reaches an upper limit cathode pressure higher than the predetermined first cathode pressure, close the oxygen tank valve.

3. The fuel cell system according to claim 2, further comprising an exhaust oxygen pipe connected to the cathode gas outlet, wherein the exhaust oxygen valve is provided in the exhaust oxygen pipe.

4. The fuel cell system according to claim 1, wherein the controller is configured to, when activating or stopping the fuel cell stack, output the signal indicating the occurrence of the oxygen leakage in a case where the cathode internal pressure after the predetermined period is not lower than the predetermined second cathode pressure and an amount of decrease in an internal pressure of the oxygen pipe on an upstream side of the oxygen stop valve during the predetermined period is larger than a permissible decrease amount.

5. The fuel cell system according to claim 1, further comprising a first pressure sensor provided in the oxygen pipe on a downstream side of the oxygen stop valve and configured to measure the cathode internal pressure, wherein the controller is configured to acquire the measured cathode internal pressure from the first pressure sensor.

6. The fuel cell system according to claim 2, further comprising a second pressure sensor provided in the oxygen pipe on the upstream side of the oxygen stop valve and configured to measure the internal pressure of the oxygen pipe on the upstream side of the oxygen stop valve, wherein the controller is configured to acquire the measured internal pressure from the second pressure sensor.
